(19) United States
(12) Patent Application Publication
(10) Pub. No.: US 2009/0244707 A1
(43) Pub. Date: Oct. 1, 2009

(54) VEHICLE ACCESSORY

(75) Inventor: Hideyuki KIKUCHI, Fujieda-shi (JP)

Correspondence Address: GREENBLUM & BERNSTEIN, P.L.C., 1950 ROLAND CLARKE PLACE, RESTON, VA, 20191, US

(73) Assignee: MURAKAMI CORPORATION, Shizuoka (JP)

(21) Appl. No.: 12/361,143

(22) Filed: Jan. 28, 2009

(30) Foreign Application Priority Data
Mar. 31, 2008 (JP) 2008-092175

(51) Int. Cl. G02B 27/00

(52) U.S. Cl. 359/601

(57) ABSTRACT

The present invention provides a vehicle accessory which always provides good visibility, can easily be installed, and has excellent appearance. The vehicle accessory includes a light controlling sheet which is attached on a windshield of a vehicle, a rearview mirror, and a mirror support member. The rearview mirror has a mirror housing, a mirror plate, a front light receiving sensor, and a rear light receiving sensor, and the mirror housing encloses a circuit board which applies a value of voltage according to a received light quantity of the rear light receiving sensor to the mirror plate, and applies a value of voltage according to a received light quantity of the front light receiving sensor to the light controlling sheet, and a power supply unit which supplies power to the circuit board. Wires and electrode lead out portions are enclosed in the mirror support member connected to the inside of the mirror housing.

### CROSS-REFERENCE TO RELATED APPLICATIONS

This disclosure of Japanese Patent Application No. JP2008-092175 filed on Mar. 31, 2008 including the specification, drawings and abstract is incorporated herein by in its entirety.

### BACKGROUND OF THE INVENTION

1. Field of the Invention

The present invention relates to a vehicle accessory including a light controlling sheet which is attached to the windshield and functions as a sun visor, and a rearview mirror for ensuring rear view of the vehicle.

2. Related Background Art

When a vehicle is traveling, sun light may enter the eyes of the driver and passenger, making it difficult to view to the front due to glare. In order to suppress this glare, a sun visor is used, as disclosed in Japanese Patent Application Laid-Open No. 2002-67690. This sun visor is comprised of a liquid crystal visor element secured in the windshield so as to shield the sun light that enters the eyes of the driver and passenger, and an incident direction sensor which is secured on the windshield or dashboard for detecting light, where the transparent state of the liquid crystal visor element changes when the incident direction sensor detects light.

### SUMMARY OF THE INVENTION

In the case of the above mentioned sun visor according to Japanese Patent Application Laid-Open No. 2002-67690, the incident direction sensor must be secured on the dashboard or windshield. In order to secure the incident direction sensor on the dashboard, a wire for connecting the incident direction sensor and the liquid crystal visor element must be routed along the front pillar, which makes the wiring long and complicated. Therefore installation takes time. In the case of securing the incident direction sensor on the windshield, on the other hand, the incident direction sensor blocks the view of the driver and passenger. This makes visibility to the front poor, and spoils appearance.

With the foregoing in view, it is the present invention to provide vehicle accessory which can be easily installed without blocking visibility, and which is excellent in appearance.

A vehicle accessory of the present invention has a light controlling sheet which is attached on a windshield of a vehicle, a rearview mirror which ensures the rear view of the vehicle, and a mirror support member which is secured on the windshield and supports the rearview mirror, wherein the rearview mirror has: a mirror housing which is connected to the mirror support member; a mirror plate of which light reflectance changes according to a value of voltage; a front light receiving sensor which detects light which entered from the front of the vehicle; and a rear light receiving sensor which detects light which entered from the rear of the vehicle, the light controlling sheet is a flexible transparent sheet of which light transmittance changes according to the value of voltage, and the mirror housing encloses a circuit board which applies a voltage according to a received light quantity of the rear light receiving sensor to the mirror plate, and applies a value of voltage according to a received light quantity of the front light receiving sensor to the light controlling sheet, and a power supply unit which supplies power to the circuit board.

According to this vehicle accessory, when the front light receiving sensor detects the light irradiated from the front of the vehicle, a value of voltage according to this received light quantity is applied to the light controlling sheet from the circuit board, and the light transmittance of the light controlling sheet changes. This light controlling sheet is attached on the windshield, so the quantity of the light which enters through the windshield can be adjusted to the received light quantity of the front light receiving sensor. Therefore if strong light is irradiated from the front, the incident light quantity through the windshield can be decreased, and if the light coming from the front is weak, the light can be entered as is through the windshield. As a result, the front can be viewed without experiencing glare when the sun is strong, or in natural brightness when weather is cloudy. The front light receiving sensor is disposed in the mirror housing, so the front light receiving sensor does not block the view of the driver and passenger. Hence the present invention can maintain good front visibility.

Also according to this vehicle accessory, the rear light receiving sensor detects light from the rear of the vehicle, and the circuit board generates a value of voltage according to the received light quantity of the rear light receiving sensor, so a value of voltage according to the quantity of light from the rear can be obtained. This voltage is applied to the mirror plate, and the light reflectance of the mirror plate changes according to the value of the voltage, so the light reflectance of the mirror can be a value corresponding to the quantity of light from the rear. Therefore when a strong light enters from the rear, the light reflectance of the mirror plate can be decreased, and the rearview mirror can be used as an anti-glare mirror. Hence according to the present invention, good visibility can be maintained not only for the front but also for the rear.

According to this vehicle accessory, the circuit board is enclosed in the mirror housing and the light controlling sheet is attached on the windshield. Therefore the circuit board and light controlling sheet are relatively close, and the wire connecting them can be short. Since the routing of the wire for a long distance is unnecessary, installation is easier. And not only the circuit board, but also the power supply to supply power to the circuit board is also enclosed in the mirror housing, so the routing of the wire for a long distance is unnecessary for the wire connecting the circuit board and the power supply as well. The wire connecting the circuit board and light controlling sheet is short and therefore does not standout. As a result, appearance can be improved.

In the vehicle accessory of the present invention, it is preferable that the wire for connecting the light controlling sheet and circuit board, and a portion of the light controlling sheet which is connected to the wire, are enclosed in the mirror support member connected to the inside of the mirror housing.

According to this vehicle accessory, the circuit board and light controlling sheet are connected via a wire. Inside the mirror housing, which encloses the circuit board, is connected with inside the mirror support member. Inside the mirror support member also encloses the connecting portion of the light controlling sheet. Therefore the circuit board and light controlling sheet can be connected by inserting the wire into the mirror support member. This prevents the unnecessary routing of wire with certainty. This wire is disposed inside the mirror support member, so it is concealed from the outside. This is the same for the connecting portion of the light controlling sheet. Since the wire and connecting portion are not visible, appearance further improves.

In the vehicle accessory of the present invention, it is preferable that the mirror plate has: a pair of transparent glass plates; a guest host liquid crystal layer which is inserted between the pair of transparent glass plates and of which light transmittance changes according to a value of voltage; and a reflective film.

According to this vehicle accessory, the mirror plate includes the liquid crystal layer of which light transmittance changes according to a value of voltage, and a reflective film. Therefore if voltage is applied to this mirror plate, the light transmittance of the liquid crystal layer changes, and the quantity of light to be reflected by the reflective film changes accordingly, and as a result, the reflectance changes. Hence the light reflectance of the mirror plate can be changed according to a value of voltage without fail.

In the vehicle accessory of the present invention, it is preferable that the mirror plate has: a pair of transparent glass plates; an electro-chromic layer which is inserted between the pair of transparent glass plates and of which light transmittance changes according to a value of voltage; and a reflective film.

According to this vehicle accessory, the mirror plate includes the electro-chromic layer of which light transmittance changes according to a value of voltage, and the reflective film. Therefore if voltage is applied to this mirror plate, the light transmittance of the electro-chromic layer changes, and the quantity of light to be reflected by the reflective film changes accordingly, and as a result, the reflectance changes.

In the vehicle accessory of the present invention, it is preferable that the light controlling sheet has: a pair of transparent films; and a guest host liquid crystal layer which is inserted between the pair of transparent films and of which light transmittance changes according to a value of voltage.

According to this vehicle accessory, the light controlling sheet includes the liquid crystal layer of which light transmittance changes according to a value of the voltage, so the light transmittance of the light controlling sheet can be changed according to a value of the voltage without fail.

In the vehicle accessory of the present invention, it is preferable that the light controlling sheet has a pair of transparent films, and an electro-chromic layer which is inserted between the pair of transparent films and of which light transmittance changes according to a value of voltage.

According to this vehicle accessory, the light controlling sheet includes the electro-chromic layer of which light transmittance changes according to a value of the voltage, so the light transmittance of the light controlling sheet can be changed according to a value of voltage without fail.

In the vehicle accessory of the present invention, it is preferable that the light controlling sheet has an achromatic color before and after the change of the light transmittance.

According to this vehicle accessory, the light controlling sheet has an achromatic color before and after the change of the light transmittance, so the color of a traffic light, sign posts or the like can be clearly identified regardless the change of light transmittance. This makes the visibility of front viewing better.

In the vehicle accessory of the present invention, it is preferable that the light controlling sheet has: a first light controlling sheet portion which is attached on a driver's seat side of the windshield; a second light controlling sheet portion which is attached on a passenger's seat side of the windshield; and a third light controlling sheet portion which is positioned between the first light controlling sheet portion and the second light controlling sheet portion, the first to third light controlling sheet portions being electrically connected.

According to this vehicle accessory, the light controlling sheet is separated into three light controlling sheet portions, attaching is thereby easy. The first light controlling sheet portion can have a tone with which the driver sitting in the driver's seat can easy see the front, the second light controlling sheet portion can have a different tone with which a passenger setting in the passenger's seat can easily see the front, and the third light controlling sheet portion can have yet a different tone with which both the driver sitting in the driver's seat and the passenger sitting in the passenger's seat can easily see out the front. Therefore visibility in the front can be further improved.

In the vehicle accessory of the present invention, the front light receiving sensor has: a driver's seat side sensor which is positioned at a driver's seat side of the mirror housing; a passenger's seat side sensor which is positioned at a passenger's seat side of the mirror housing; and a center portion sensor which is positioned between the driver's seat side sensor and the passenger's seat side sensor, the light controlling sheet has: a first light controlling sheet portion which is attached on a driver's seat side of the windshield; a second light controlling sheet portion which is attached on a passenger's seat side of the windshield; and a third light controlling sheet portion which is positioned between the first light controlling sheet portion and the second light controlling sheet portion, and the circuit board applies a value of voltage according to a received light quantity of the driver's seat side sensor to the first light controlling sheet portion, applies a value of voltage according to a received light quantity of the passenger's seat side sensor to the second light controlling sheet portion, and applies a value of voltage according to a received light quantity of the center portion sensor to the third light controlling sheet portion.

According to this vehicle accessory, the circuit board applies a value of voltage according to the received light quantity of the driver's seat side sensor to the first light controlling sheet portion, applies a value of voltage according to the received light quantity of the passenger's seat side sensor to the second light controlling sheet portion, and applies a value of voltage according to the received light quantity of the center portion sensor to the third light controlling sheet portion. Therefore the first to third light controlling sheet portions can be operated independently. Thereby the light transmittance can be decreased only for the first light controlling sheet portion, for example, and the driver can clearly see outside via the center portion and the passenger's seat portion of the windshield, in a state where glare is decreased.

### BRIEF DESCRIPTION OF THE DRAWINGS

FIG. 1 is a perspective view depicting a vehicle having the vehicle accessory according to the present invention;

FIG. 2 is a plan view depicting a first embodiment of the vehicle accessory according to the present invention;

FIG. 3 is a cross-sectional view depicting the vehicle accessory shown in FIG. 1;

(a) of FIG. 4 is a cross-sectional view depicting a mirror plate according to the first embodiment, and (b) of FIG. 4 is a cross-sectional view depicting a light controlling sheet according to the first embodiment;

FIG. 5 is a plan view depicting the second embodiment of the vehicle accessory according to the present invention;

FIG. 6 is a plan view depicting the third embodiment of the vehicle accessory according to the present invention;

(a) of FIG. 7 is a cross-sectional view depicting a first variant form of the mirror plate, and (b) of FIG. 7 is a cross-sectional view depicting a second variant form of the mirror plate; and

(a) of FIG. 8 is a cross-sectional view of a third variant form of the mirror plate; and (b) of FIG. 8 is a cross-sectional view depicting a fourth variant form of the mirror plate.

### DESCRIPTION OF THE PREFERRED EMBODIMENTS

Preferred embodiments of a rearview mirror according to the present invention will now be described with reference to the drawings.

### First Embodiment

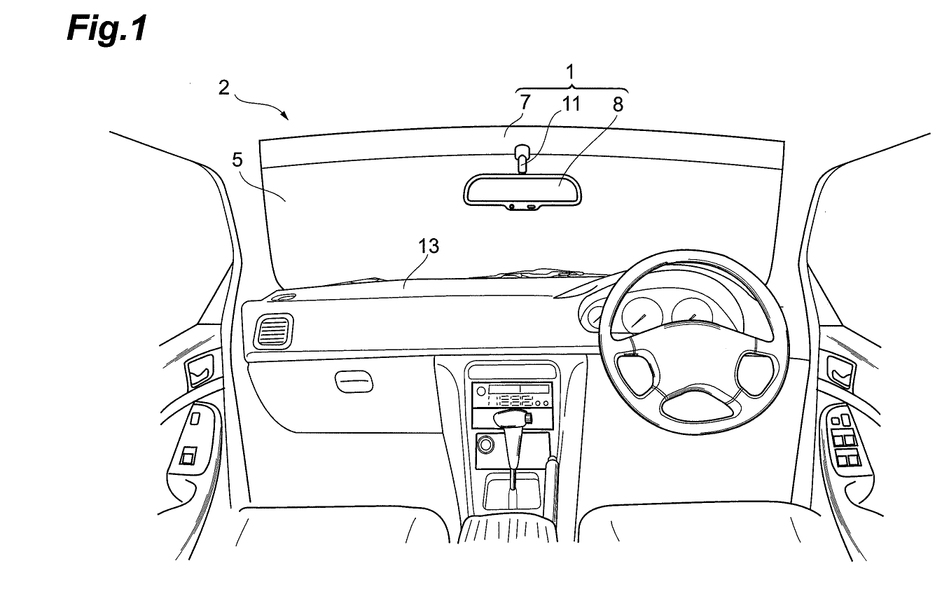

As FIG. 1 to FIG. 3 show, a vehicle accessory has a light controlling sheet 7 for preventing glare by light, particularly sun light, from the front, and a rearview mirror 8 for ensuring the rear view of a vehicle 2. The light controlling sheet is attached on a windshield 5, and the rearview mirror 8 is supported by a mirror support member 11 which is secured to the windshield 5.

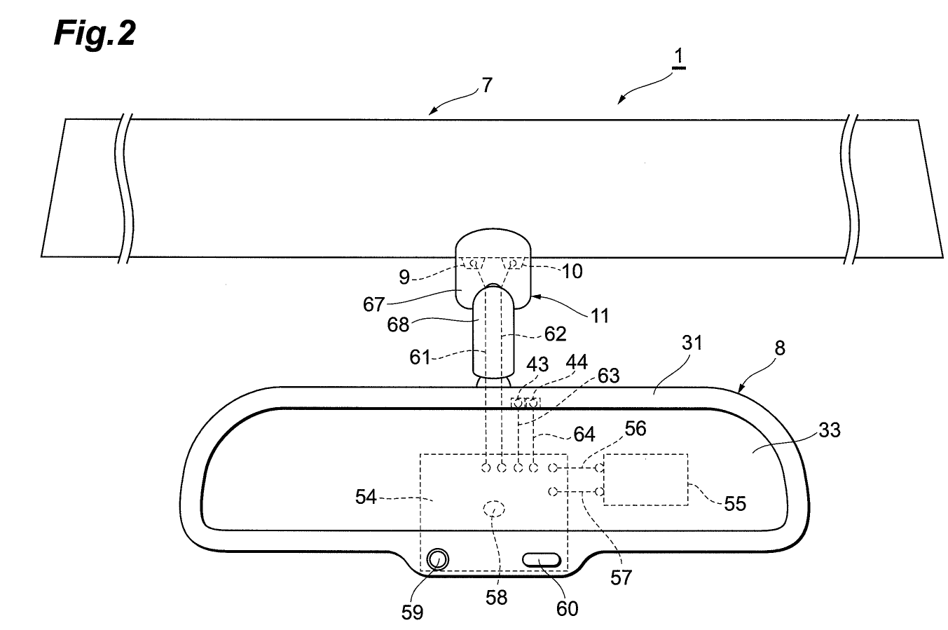

The light controlling sheet 7 is a flexible transparent sheet and is attached on the upper portion of the windshield 5 so as to block the sun light. The light controlling sheet 7 is rectangular, and is attached such that the longitudinal direction is along the width direction of the windshield 5. As FIG. 2 shows, a pair of electrode lead out portions 9 and 10, for applying voltage to the light controlling sheet 7, protrude from the edge of the light controlling sheet 7, and the electrode lead out portions 9 and 10 are positioned around the center in the longitudinal direction of the light controlling sheet 7. The electrode lead out portions 9 and 10 are covered by the mirror support member 11.

In the light controlling sheet 7 of which light transmittance changes, a guest host liquid crystal layer 21 is disposed between a pair of transparent films 15 and 16 as (a) of FIG. 4 shows. The guest host liquid crystal layer 21 is a layer containing liquid crystals and dye, and transmits light when voltage is not applied, but if voltage is applied, the orientation direction of the guest host liquid crystal layer 21 changes, and the guest host crystal layer 21 becomes a colored state, and light transmittance drops. The guest host liquid crystal layer 21 is between a pair of orientation films 17 and 19, and the edge of the guest host liquid crystal layer 21 is sealed with adhesive 23. In the guest host liquid crystal layer 21, transparent conductive films 25 and 26 for applying voltage are formed between the transparent films 15 and 16 and the orientation films 17 and 19. A part of the transparent conductive films 25 and 26 protrudes from the adhesive 23, and becomes electrode lead out portions 9 and 10 of the light controlling sheet 7. In the light controlling sheet 7, the range of the light transmittance variable ratio is increased by using the guest host liquid crystal layer 21.

Concerning the materials of each composing element, an example of the transparent films 15 and 16 is PET (polyethylene terephthalate). If PET is used for the transparent films 15 and 16, flexibility of the light controlling sheet 7 becomes very good, and the light controlling sheet 7 can be attached on the windshield 5 via adhesive. An example of the material of the orientation films 17 and 19 is polyimide resin, and examples of the material of the transparent conductive films 25 and 26 are ITO (indium tin oxide) and SnO₂ (tin oxide). The light controlling sheet 7 is always an achromatic color, regardless the light transmittance of the guest host liquid crystal layer 21. Therefore the color of traffic lights, sign posts or the like can always be identical in a state where the light controlling sheet 7 is attached. The guest host liquid crystal layer 21 has an achromatic color, and when the tone is represented by an L*a*b* color system, a* and b* values are within ±30, more preferably ±20.

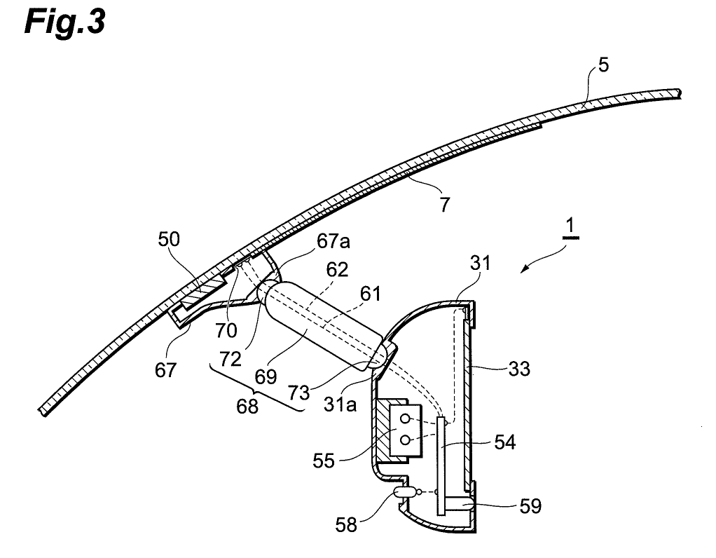

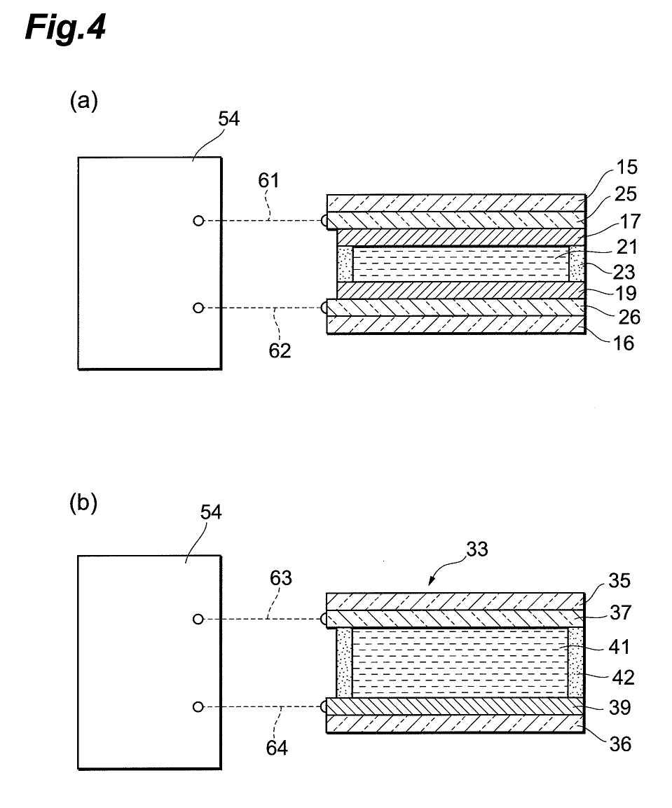

As FIG. 2 and FIG. 3 show, the rearview mirror 8 disposed diagonally at the front of the driver has a mirror housing 31 made of resin, and a mirror plate 33, which is secured on the front face of the mirror housing 31 and has electrode lead out portions 43 and 44. The rearview mirror 8 is installed such that the front face of the mirror housing 31 faces the back of the vehicle 2, and the rear face of the mirror housing 31 faces the front of the vehicle 2.

In the mirror plate 33 of which light reflectance changes, an electro-chromic layer 41 of which edge is sealed with adhesive 42 is disposed between a pair of glass plates 35 and 36 as (b) of FIG. 4 shows. The electro-chromic layer 41 is a layer containing electro-chromic material and solvent, and transmits light as is when voltage is not applied, but if voltage is applied, the electro-chromic layer 41 becomes a colored state because of an oxidation reduction reaction, and its light transmittance drops. Voltage is applied to the electro-chromic layer 41 via a transparent conductive film 37 and reflective film 39 which sandwich the electro-chromic layer 41. A part of the transparent conductive film 37 and the reflective film 39 protrudes from the adhesive 42, and becomes the electrode lead out portions 43 and 44 of the mirror plate 33.

In the mirror plate 33 having the above configuration, the light transmittance of the electro-chromic layer 41 changes according to a value of voltage applied via the transparent conductive film 37 and the reflective film 39, and the quantity of light which enters the reflective film 39 also changes. Therefore the light reflectance of the mirror plate 33 changes according to the magnitude of voltage. An example of the electro-chromic material is viologen, and an example of the solvent is propylene carbonate. Examples of the material of the transparent conductive film 37 are ITO and SnO₂, and examples of the material of the reflective film 39 are Rh, Ag, Al, Cr and Ru.

As FIG. 2 and FIG. 3 show, a circuit board 54 for applying voltage to the mirror plate 33 and the light controlling sheet 7, and a power supply portion 55 for supplying power to the circuit board 54, are enclosed inside the mirror housing 31. The power supply portion 55 has a built-in battery, and the power supply portion 55 and the circuit board 54 are connected with wires 56 and 57 which are lead wires. Power is supplied from the power supply portion 55 to the circuit board 54 via these wires 56 and 57. Since the power supply portions 55 is in the mirror housing 31, the wire to supply power to the circuit board 54 can be short.

A front light receiving sensor 58, for detecting light which enters from the front of the vehicle 2 and a rear light receiving sensor 59, for detecting light which enters from the rear of the vehicle 2, are connected to the circuit board 54. The front light receiving sensor 58 is exposed around the center of the rear face of the mirror housing 31, and the rear light receiving sensor 59 and a switch 60 are exposed from the lower center of the front face of the mirror housing 31.

A push button type switch 60, which controls the ON/OFF of the front light receiving sensor 58 and the rear light receiving sensor 59, is connected to the circuit board 54. The front light receiving sensor 58 and the rear light receiving sensor 59 can receive light when the switch 60 is turned ON. If the front light receiving sensor 58 receives light in this state, the circuit board 54 applies a value of voltage according to the received light quantity of the front light receiving sensor 58 to the light controlling sheet 7 via the wires 61 and 62, which are lead wires. If the rear light receiving sensor 59 receives light, the circuit board 54 compares the received light quantity of the front light receiving sensor 58 and the received light quantity of the rear light receiving sensor 59, and applies voltage according to the difference thereof to the mirror plate 33 via the wires 63 and 64, which are lead wires, if the received light quantity of the rear light receiving sensor 59 is higher. In the present embodiment, voltage according to the difference of the received light quantities is applied to the mirror plate 33, but voltage according to the received light quantity of the rear light receiving sensor 59 alone may be applied to the mirror plate 33.

The rearview mirror 8 enclosing the circuit board 54 is supported by the mirror support member 11. The mirror support member 11 comprises a base 67 which is attached to an installation plate 50 secured to the windshield 5 by bonding, and a stay 68 of which one end is connected to a base 67 and the other end is connected to the mirror housing 31.

The removable base 67, formed of opaque resin or metal, is secured to the installation plate 50. An opening 70 for exposing the electrode lead out portions 9 and 10 of the light controlling sheet 7 is created on the rear face of the base 67, that is on a surface facing the windshield 5. The base 67 is disposed on the windshield 5 so that the opening 70 covers the electrode lead out portions 9 and 10, and the base 67 is formed of opaque resin or metal, therefore the electrode lead out portions 9 and 10 are invisible from outside view.

The stay 68 is an element to support the rearview mirror 8 which can be freely tilted, and has a stay main body 69 which protrudes from the windshield 5 to inside the vehicle, and spherical pivots 72 and 73 which are disposed at both ends of the stay main body 69. The pivot 72 is connected to a concave portion 67a on the front face of the base 67, and the pivot 73 is connected to a concave portion 31a on the rear face of the mirror housing 31 via a ball joint structure respectively.

The insides of the stay main body 69 and the pivots 72 and 73 are hollow and connected. The inside of the pivot 72 is connected to the inside of the base 67, and the inside of the pivot 73 is connected to the inside of the mirror housing 31. In the internal space of the stay 68 and pivots 72 and 73, wires 61 and 62 which connect the electrode lead out portions 9 and 10 of the light controlling sheet 7 and the circuit board 54, are enclosed, and the wires 61 and 62 penetrate through the inside of the stay 68 and pivots 72 and 73. The stay main body 69 and pivots 72 and 73 are formed of opaque resin or metal. Therefore the wires 61 and 62 are invisible from outside view.

As described above, in the vehicle accessory 1, the circuit board 54 is enclosed in the mirror housing 31, and the inside of the mirror housing 31 is connected with the inside of the base 67 and the stay 68. In the base 67, the electrode lead out portions 9 and 10 of the light controlling sheet 7 are enclosed, and the electrode lead out portions 9 and 10 are connected with the wires 61 and 62. Therefore the circuit board 54 and the electrode lead out portions 9 and 10 can be connected simply by inserting the wires 61 and 62 into the stay 68 and base 67, and since the base 67 and stay 68 are near the mirror housing 31 and light controlling sheet 7, it is unnecessary to route the wires 61 and 62 over a long distance. At the connection, the wires 61 and 62 are guided on the inner wall face of the stay 68, so the connection operation can be performed smoothly. Installation of the vehicle accessory 1, which does not require long distance wire routing and of which connection operation is smooth, is therefore easy.

Also in the vehicle accessory 1, the wires 61 and 62 and electrode lead out portions 9 and 10 of the light controlling sheet 7 are enclosed inside the base 67 and stay 68. By concealing the wires 61 and 62 and the connection portions thereof without exposure, appearance improves.

In the vehicle accessory 1, when the front light receiving sensor 58 detects light, a value of voltage according to the received light quantity is applied from the circuit board 54 to the light controlling sheet 7, and the light transmittance of the light controlling sheet 7 drops. The light controlling sheet 7 is attached on the windshield 5, so the lightness in front drops substantially when sun light entering diagonally from the upper front area is strong, otherwise lightness remains the lightness of the windshield 5 itself or close to this. As a result, the driver and passengers can see a clear front view without glare. In the vehicle accessory 1, the front light receiving sensor 58 is disposed in the mirror housing 31, so the front light receiving sensor 58 does not block the front view.

In the vehicle accessory 1, when the rear light receiving sensor 59 detects light, a value of voltage according to the received light quantity is applied from the circuit board 54 to the mirror plate 33, and light reflectance of the mirror plate 33 drops. Therefore the rearview mirror 8 can also function as an anti-glare mirror. As a result, not only the front but the rear visibility as well can be improved.

In the vehicle accessory 1, the front light receiving sensor 58 is shared by the light controlling sheet 7 and the mirror plate 33. Therefore it is unnecessary to provide a front light receiving sensor for the light controlling sheet 7 and a front light receiving sensor for the mirror plate 33 separately. Also the circuit board 54 applies voltage to both the light controlling sheet 7 and mirror plate 33. Therefore it is unnecessary to provide a circuit board for applying voltage to the light controlling sheet 7 and a circuit board for applying voltage to the mirror plate 33 separately. As a result, a number of components can be decreased.

In the first embodiment, the wires 61 and 62 and the electrode lead out portions 9 and 10 are enclosed inside the base 67 and stay 68, but these may be exposed, and may be disposed along the side faces of the base 67 and stay 68, for example. To be disposed along the side faces, the wires 61 and 62 and electrode lead out portions 9 and 10 may be attached to the base 67 and stay 68. Even if the wires 61 and 62 and electrode lead out portions 9 and 10 are exposed like this, the electrode lead out portions 9 and 10 are not noticeable since the length of the wires is short. As a result, good appearance is ensured.

The configuration of the light controlling sheet 7 is not limited to the above mentioned one. For example, an electro-chromic layer may be disposed in an area where the guest host liquid crystal layer 21, the pair of orientation films 17 and 19, and the adhesive 23 are disposed, as shown in (a) of FIG. 4. For this electro-chromic layer, material the same as that of the electro-chromic layer 41 of the mirror plate 33 can be used.

### Second Embodiment

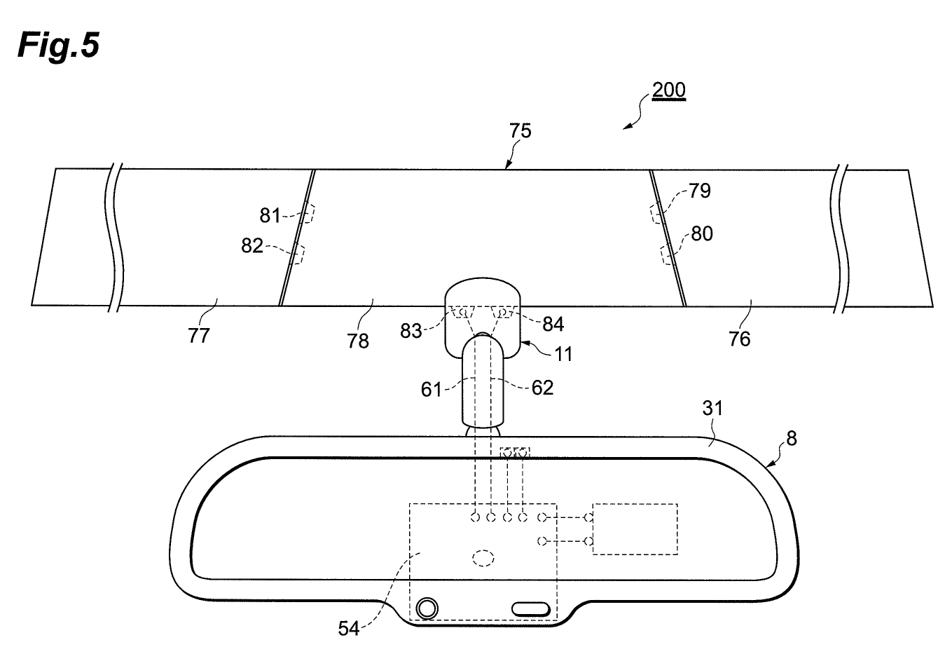

As shown in FIG. 5, in a vehicle accessory according to the second embodiment, the above mentioned light controlling sheet of the first embodiment is separated into three portions.

The vehicle accessory 200 according to the second embodiment has a light controlling sheet 75 which is separated into three portions. The light controlling sheet 75 is composed of first to third light controlling sheet portions 76 to 78 that can be separated, and the internal structures of the first to third light controlling sheet portions 76 to 78 are the same as that of the light controlling sheet 7 of the first embodiment respectively. The first light controlling sheet portion 76 is attached on the driver's seat side of the windshield 5, the second light controlling sheet portion 77 is attached on the passenger's seat side of the windshield 5, and the third light controlling sheet portion 78 is positioned between the first light controlling sheet portion 76 and the second light controlling sheet portion 77.

In the light controlling sheet 75 attached on the windshield 5, a pair of electrode lead out portions 79 and 80 of the first light controlling sheet portion 76 and a pair of electrode lead out portions 81 and 82 of the second light controlling sheet portion 77 protrude toward the third light controlling sheet portion 78 and contact a transparent conductive film of the third light controlling sheet portion 78. Thereby the first to third light controlling sheet portions 76 to 78 are electrically connected. A pair of electrode lead out portions 83 and 84 of the third light controlling sheet portion 78 protrude toward the dashboard 13, and are enclosed in the mirror support member 11. The electrode lead out portions 83 and 84 are connected to the circuit board 54 via the wires 61 and 62, just like the electrode lead out portions 9 and 10 of the first embodiment.

If the light controlling sheet 75 is composed of the first to third light controlling sheet portions 76 to 78 that can be separated like this, a different dye can be used for the respective guest host liquid crystal layer of each light controlling sheet portion. Therefore a tone, with which the front view can be easily seen from the driver's seat, can be used for the first light controlling sheet portion 76, a tone, with which the front view can be easily seen from the passenger's seta, can be used for the second light controlling sheet portion 77, and a tone, with which the front view can be easily seen from both the driver's seat and passenger's seat, can be used for the third light controlling sheet portion 78. As a result, front visibility can be further improved. The light controlling sheet 35 that can be separated into three portions can also be easily attached on the windshield 5.

### Third Embodiment

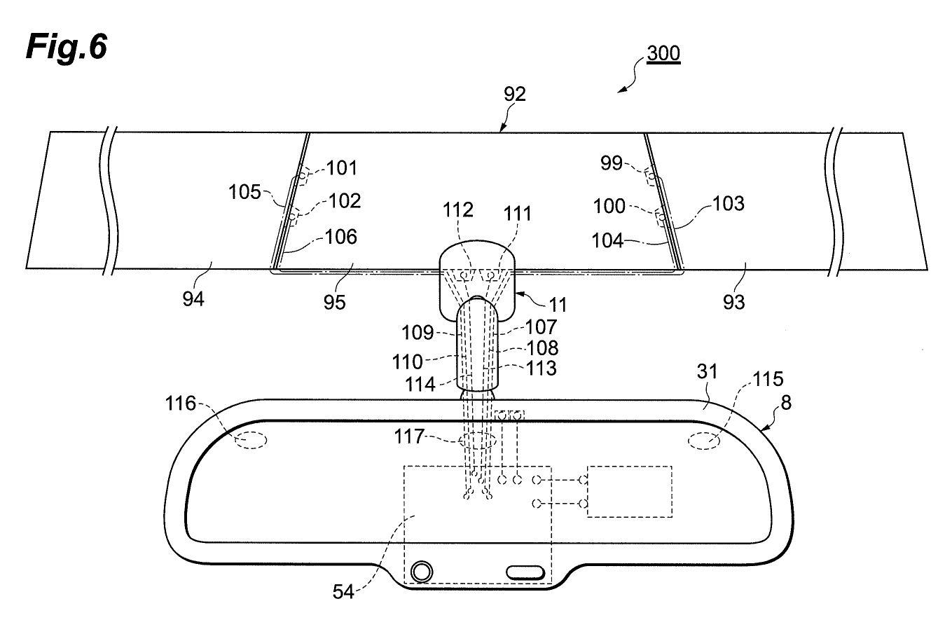

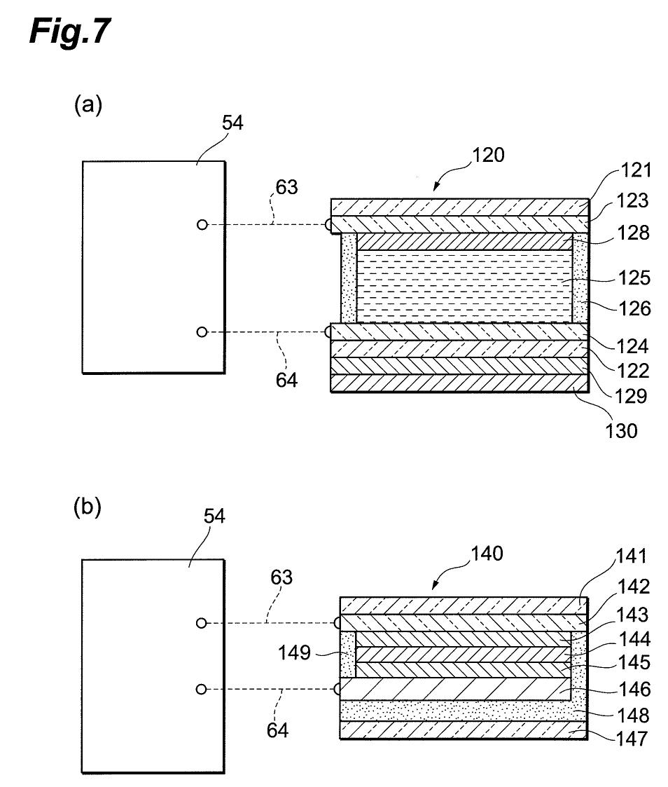

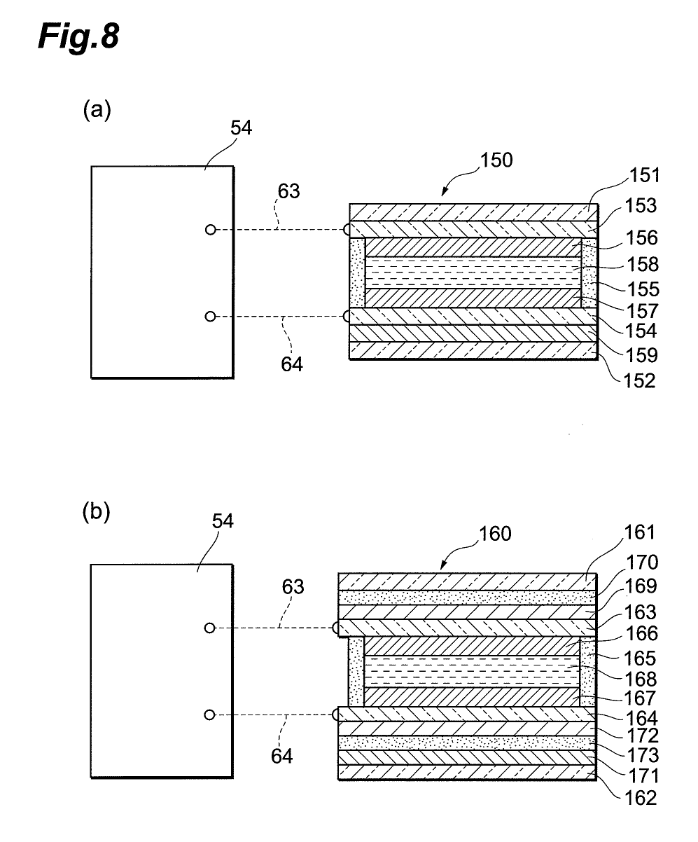

As shown in FIG. 6, in a vehicle accessory according to the third embodiment, the above mentioned light controlling sheet of the first embodiment is separated into three portions, and three front light receiving sensors are provided.

The vehicle accessory 300 according to the third embodiment has a light controlling sheet 92 which is separated into three portions. The light controlling sheet 92 is composed of first to third light controlling sheet portions 93 to 95 that can be separated, and the internal structures of the first to third light controlling sheet portions 93 to 95 are the same as that of the light controlling sheet 7 of the first embodiment respectively. The first light controlling sheet portion 93 is attached on the driver's seat side of the windshield 5, the second light controlling sheet portion 94 is attached on the passenger's seat side of the windshield 5, and the third light controlling sheet portion 95 is positioned between the first light controlling sheet portion 93 and the second light controlling sheet portion 94.

In the light controlling sheet 92 attached on the windshield 5, a pair of electrode lead out portions 99 and 100 of the first light controlling sheet portion 93 and a pair of electrode lead out portions 101 and 102 of the second light controlling sheet portion 94 protrude toward the third light controlling sheet portion 95. The electrode lead out portions 99 to 102, however, are not connected to the transparent conductive film of the third light controlling sheet portion 95, so the first to third light controlling sheet portions 93 to 95 are electrically insulated. A pair of electrode lead out portions 111 and 112 of the third light controlling sheet portion 95 protrude toward the dashboard 13, and are enclosed in the mirror support member 11.

The electrode lead out portions 99 to 102 of the first and second light controlling sheet portions 93 and 94 are connected to one end of the wires 103 to 106, which are lead wires or conductive transparent tape. The other ends of the wires 103 to 106 are positioned in the opening of the base 67. The wires 107 to 110, which are lead wires, are connected to the other ends of the wires 103 to 106, and the wires 107 to 110 are connected to the circuit board 54 via inside the mirror support member 11. The electrode lead out portions 111 and 112 of the third light controlling sheet portions 95 are connected to the circuit board 54 via the wires 113 and 114, which are lead wires.

The first to third front light receiving sensors 115 to 117 are connected to the circuit board 54. The first to third front light receiving sensors 115 to 117 are exposed from the rear face of the mirror housing 31 respectively. The first front light receiving sensor (driver's seat side sensor) 115 is positioned at the driver's seat side of the mirror housing 31, the second front light receiving sensor (passenger's seat side sensor) 116 is positioned at the passenger's seat side of the mirror housing 31, and the third front light receiving sensor (center portion sensor) 117 is positioned between the first front light receiving sensor 115 and the second front light receiving sensor 116.

When the first front light receiving sensor 115 receives light, a value of voltage according to this received light quantity is applied from the circuit board 54 to the electrode lead out portions 99 and 100 of the first light controlling sheet portion 93 via the wires 107 and 108. When the second front light receiving sensor 116 receives light, a value of voltage according to this received light quantity is applied from the circuit board 54 to the electrode lead out portions 101 and 102 of the second light controlling sheet portion 94 via the wires 109 and 110. When the third front light receiving sensor 117 receives light, a value of voltage according to this received light quantity is applied from the circuit board 54 to the electrode lead out portions 111 and 112 of the third light controlling sheet portion 95 via the wires 113 and 114.

If the first to third light controlling sheet portions 93 to 95 and the corresponding first to third front light receiving sensors 115 to 117 are provided like this, the first to third light controlling sheet portions 93 to 95 can be controlled independently. Thereby the light transmittance can be decreased only for the first light controlling sheet portion 93, for example, and in this case, the driver can see sights outside through the center portion and the passenger's seat side portion of the windshield 5 without a drop in lightness, in a state of reduced glare. As a result, front visibility can be further improved.

Now various variant forms to be applied to the mirror plate 33 of the first to third embodiment will be described.

As (a) of FIG. 7 shows, a mirror plate 120 according to a first variant form has a pair of transparent glass plates 121 and 122, and an electro-chromic layer 125, which is positioned between the glass plates 121 and 122, and is also sandwiched by transparent conductive films 123 and 124. A circular adhesive 126 is placed between the transparent conductive films 123 and 124, and the electro-chromic layer 125 is disposed in an area enclosed by the adhesive 126. A WO₃ layer 128 is formed between the electro-chromic layer 125 and the transparent conductive film 123. A reflective film 129 is formed on the surface opposite the transparent conductive film 124 on the glass plate 122, and an exposed surface of the reflective film 129 is covered by a protective material 130. A part of the transparent conductive films 123 and 124 protrudes from the adhesive 126, and these protruding portions become the electrode lead out portions of the mirror plate 120, and is connected with the circuit board 54 via the wires 63 and 64.

The material of the transparent conductive films 123 and 124 is the same as that of the transparent conductive film 37 of the first embodiment, and the material of the electro-chromic layer 125 is the same as that of the electro-chromic layer 41 of the first embodiment. The material of the reflective film 129 is the same as that of the reflective film 39 of the first embodiment.

As (b) of FIG. 7 shows, the mirror plate 140 of the second variant form has a transparent glass plate 141, transparent conductive film 142, IrOx layer 143, Ta₂O₅ layer 144, WO₃ layer 145, reflective film 146, and transparent glass plate 147, which are layered in this order. The transparent conductive film 142 and glass plate 147, and the reflective film 146 and glass plate 147 are bonded with adhesive 148 respectively. The transparent conductive film 142 and reflective film 146 are also bonded with adhesive 149. In the mirror plate 140, the transparent conductive film 142 and reflective film 146 are connected with the circuit board 54 via the wires 63 and 64.

An example of the material of the adhesives 148 and 149 is epoxy resin. The material of the transparent conductive film 142 is the same as that of the transparent conductive film 37 of the first embodiment, and the material of the reflective film 146 is the same as that of the reflective film 39 of the first embodiment.

As (a) of FIG. 8 shows, the mirror plate 150 of the third variant form has a pair of transparent glass plates 151 and 152 and a pair of transparent conductive films 153 and 154, which are positioned between the glass plates 151 and 152. The transparent conductive films 153 and 154 are bonded with a circular adhesive 155, and a guest host liquid crystal layer 158 sandwiched by a pair of orientation films 156 and 157 is disposed in an area enclosed by the adhesive 155. A reflective film 159 is formed between the transparent conductive film 154 and the glass plate 152. In the mirror plate 150, the transparent conductive films 153 and 154 are connected with the circuit board 54 via the wires 63 and 64.

The material of the transparent conductive films 153 and 154 is the same as that of the transparent conductive film 37 of the first embodiment, and the material of the reflective film 159 is the same as that of the reflective film 39 of the first embodiment. An example of the material of the orientation films 156 and 157 is polyimide resin.

As (b) of FIG. 8 shows, the mirror plate 160 of the fourth variant form has a pair of transparent glass plates 161 and 162, and a pair of transparent conductive films 163 and 164 which are positioned between the glass plates 161 and 162. The transparent conductive films 163 and 164 are bonded with a circular adhesive 165, and a guest host liquid crystal layer 168 sandwiched by a pair of orientation films 166 and 167 is disposed in an area enclosed by the adhesive 165. A plastic sheet 169 is disposed between the glass plate 161 and the transparent conductive film 163, and the plastic sheet 169 is secured on the glass plate 161 by being bonded with adhesive 170. A reflective film 171 is formed between the glass plate 162 and the transparent conductive film 164. A plastic sheet 172 is disposed between the reflective film 171 and the transparent conductive film 164. The plastic sheet 172 is secured on the reflective film 171 by being bonded with adhesive 173. In the mirror plate 160, the transparent conductive films 163 and 164 are connected with the circuit board 54 via the wires 63 and 64.

The material of the transparent conductive films 163 and 164 is the same as that of the transparent conductive film 37 of the first embodiment, the material of the reflective film 171 is the same as that of the reflective film 39 of the first embodiment, and the material of the orientation films 166 and 167 is the same as that of the orientation films 156 and 157 of the third variant form. An example of the material of the plastic sheets 169 and 172 is PET, and examples of the material of the adhesive 170 and 173 are PVB (polyvinyl butyral), EVA (ethylene-vinyl acetate), acrylic and epoxy resin.

According to the embodiments of the present invention, constant good visibility can be implemented, and installation is easy. Excellent appearance can also be implemented.

What is claimed is:

1. A vehicle accessory comprising a light controlling sheet which is attached on a windshield of a vehicle, a rearview mirror which ensures rear view of the vehicle, and a mirror support member which is secured on the windshield and supports the rearview mirror,
wherein the rearview mirror comprises:
a mirror housing which is connected to the mirror support member;
a mirror plate of which light reflectance changes according to a value of voltage;
a front light receiving sensor which detects light entered from the front of the vehicle; and
a rear light receiving sensor which detects light entered from the rear of the vehicle,
the light controlling sheet is a flexible transparent sheet of which light transmittance changes according to a value of voltage, and
the mirror housing encloses:
a circuit board which applies a value of voltage according to a received light quantity of the rear light receiving sensor to the mirror plate, and applies a value of voltage according to a received light quantity of the front light receiving sensor to the light controlling sheet; and
a power supply unit which supplies power to the circuit board.

2. The vehicle accessory according to claim 1, wherein a wire for connecting the light controlling sheet and the circuit board, and a portion of the light controlling sheet which is connected to the wire, are enclosed in the mirror support member connected to the inside of the mirror housing.

3. The vehicle accessory according to claim 1, wherein the mirror plate comprises:
a pair of transparent glass plates;
a guest host liquid crystal layer which is inserted between the pair of transparent glass plates and of which light transmittance changes according to a value of voltage; and
a reflective film.

4. The vehicle accessory according to claim 1, wherein the mirror plate comprises:
a pair of transparent glass plates;
an electro-chromic layer which is inserted between the pair of transparent glass plates and of which light transmittance changes according to a value of voltage; and
a reflective film.

5. The vehicle accessory according to claim 1, wherein the light controlling sheet comprises:
a pair of transparent films; and
a guest host liquid crystal layer which is inserted between the pair of transparent films and of which light transmittance changes according to a value of voltage.

6. The vehicle accessory according to claim 1, wherein the light controlling sheet comprises:
a pair of transparent films; and
an electro-chromic layer which is inserted between the pair of transparent films and of which light transmittance changes according to a value of voltage.

7. The vehicle accessory according to claim 1, wherein the light controlling sheet has an achromatic color before and after the change of the light transmittance.

8. The vehicle accessory according to claim 1, wherein the light controlling sheet comprises:
a first light controlling sheet portion which is attached on a driver's seat side of the windshield;
a second light controlling sheet portion which is attached on a passenger's seat side of the windshield; and
a third light controlling sheet portion which is positioned between the first light controlling sheet portion and the second light controlling sheet portion,
the first to third light controlling sheet portions being electrically connected.

9. The vehicle accessory according to claim 1, wherein the front light receiving sensor comprises:
a driver's seat side sensor which is positioned at a driver's seat side of the mirror housing;
a passenger's seat side sensor which is positioned at a passenger's seat side of the mirror housing; and
a center portion sensor which is positioned between the driver's seat side sensor and the passenger's seat side sensor,
the light controlling sheet comprises:
a first light controlling sheet portion which is attached on a driver's seat side of the windshield;
a second light controlling sheet portion which is attached on a passenger's seat side of the windshield; and
a third light controlling sheet portion which is positioned between the first light controlling sheet portion and the second light controlling sheet portion, and
the circuit board applies a value of voltage according to a received light quantity of the driver's seat side sensor to the first light controlling sheet portion, applies a value of voltage according to a received light quantity of the passenger's seat side sensor to the second light controlling sheet portion, and applies a value of voltage according to a received light quantity of the center portion sensor to the third light controlling sheet portion.
